(19) United States
(12) Patent Application Publication
(10) Pub. No.: US 2004/0226045 A1
(43) Pub. Date: Nov. 11, 2004

(54) Application services coordinated DSL-satellite multicast content delivery

(75) Inventor: Dinesh Nadarajah, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/435,598

(22) Filed: May 9, 2003

(51) Int. Cl. H04N 7/173; H04N 7/20

(52) U.S. Cl. 725/97; 725/96; 725/63

(57) ABSTRACT

A method of distributing content includes receiving at least one request for a particular content item. Based on the at least one request, a number of users who are to receive the particular content item and are capable of receiving the particular content item via a wireless link is determined. Based on the number of users, at least one of a wireline link and the wireless link from which the users are to receive the particular content item is selected. The particular content item is distributed to the users via the selected at least one link.

### BACKGROUND OF THE INVENTION

1. Field of the Invention

The present invention relates to methods and systems for delivering electronic content.

2. Description of the Related Art

As an increasing amount of digital content is being electronically distributed to end user locations, a greater need exists for multicast content delivery capabilities. In a multicast delivery, the same content (e.g. a video or a piece of subscription software) is addressed for distribution to multiple end user locations.

Satellites are well-suited for multicast content delivery. In particular, satellites are effective for distributing large quantities of data to multiple end user locations over a wide geographical area.

A current form of digital subscriber line (DSL) technology does not distribute internet protocol (IP) multicast content without implementing layer 3 routing at central offices. Without layer 3 routing, each piece of content is delivered via a respective unicast session. Using multiple unicast sessions can be resource intensive and can cause network congestion especially when transporting video and subscription software.

### BRIEF DESCRIPTION OF THE DRAWINGS

The present invention is pointed out with particularity in the appended claims. However, other features are described in the following detailed description in conjunction with the accompanying drawing in which:

FIG. 1 is a block diagram of an embodiment of a content delivery system; and

FIG. 2 is a flow chart of an embodiment of a content delivery method.

### DETAILED DESCRIPTION OF THE PREFERRED EMBODIMENTS

Disclosed herein are methods and systems that provide a seamless integration between a broadband landline network and a wireless network such as a satellite network. The system dynamically configures the two networks for multicast content delivery to end users who have access to the two networks. Some content items may have a portion that is delivered via the broadband landline network and a remaining portion that is delivered via the satellite network.

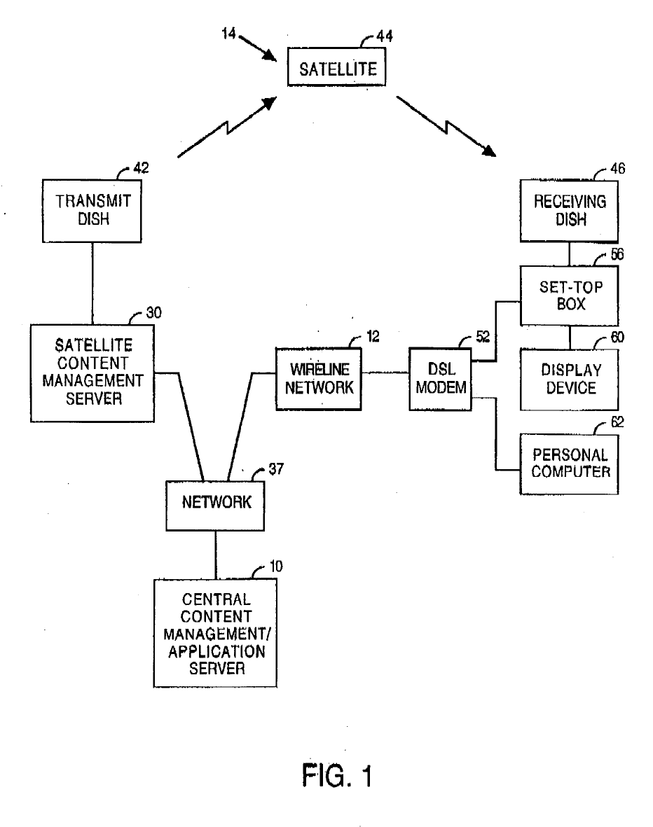

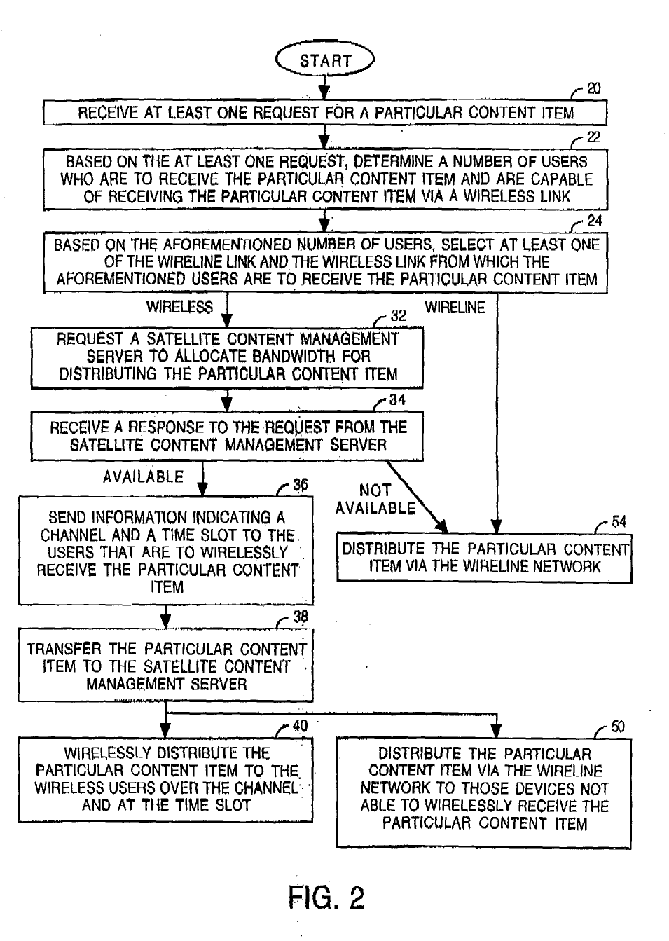

Embodiments of the present invention are described with reference to FIG. 1, which is a block diagram of an embodiment of a content delivery system, and FIG. 2, which is a flow chart of an embodiment of a content delivery method. The system is used to deliver various electronic content items to multiple users. Examples of the electronic content items include, but are not limited to, audio content such as music, video content such as movies, computer software, documentation and other rich media content. An application server 10 hosts the various electronic content items for the users to download. The application server 10 also acts to perform content management functions.

Each of the users has one or more devices in his/her customer premise or on a network to make requests for and to receive particular content items. Examples of the devices include, but are not limited to, a personal computer, a set top box (e.g. a satellite set top box), and a mobile computing device. Examples of the network include an 802.11 network such as an 802.11a network.

Some users are capable of receiving content items via a wireline link provided by a broadband wireline network 12. The broadband wireline network 12 may comprise a digital subscriber line (DSL) network, for example. Other users are capable of receiving content items via either the broadband wireline network 12 or a wireless link provided by a wireless network 14. Examples of the wireless network 14 include, but are not limited to, a satellite network and a terrestrial wireless network such as a wireless local area network (WLAN) or an Internet protocol (IP) over radio network. For purposes of illustrating one particular embodiment, the wireless network 14 is illustrated as a satellite network.

To simplify the description, the method in FIG. 2 illustrates content delivery acts for one of the content items. Those having ordinary skill should appreciate that, in practice, the method of FIG. 2 is performed for each requested content item.

As indicated by block 20, the application server 10 receives at least one request for a particular content item. Of particular interest are cases in which multiple requests for the particular content item from multiple users are received by the application server 10. The multiple requests for the same particular content item may be from several users spread over a wide geographical area. Some of the requests may be from users that are capable of receiving the particular content item via either a wireless link or a wireline link. Others of the requests may be from users that are capable of receiving the particular content item via only a wireline link.

The application server 10 stores the requests for content to be executed at a later time. The policy for executing content requests is determined by a content distributor. For example, the content requests may be executed on or after a predetermined date and time, or may be executed upon receiving at least a predetermined number of content requests for the particular content item. Thereafter, the content requests are executed as follows.

Based on the requests, the application server 10 determines a number of users who are to receive the particular content item and are capable of receiving the particular content item via a wireless link (as indicated by block 22). Based on the aforementioned number of users, the application server 10 selects at least one of the wireline link and the wireless link from which the users are to receive the particular content item (as indicated by block 24). This act may comprise comparing the aforementioned number to a preset threshold. If the aforementioned number is greater than the threshold (or is otherwise a sufficiently large number), the wireless link is selected to broadcast the particular content item to the users capable of wirelessly receiving content. If the aforementioned number is less than the threshold (or is otherwise a relatively small number), the wireline link is selected to deliver the particular content item to all of the users. In either case, the wireline link is selected to deliver the particular content item to users who do not have access to the wireless network 14.

If the wireless link is selected, and the wireless link comprises a satellite link, the application server 10 requests a satellite content management server 30 to allocate bandwidth for distributing the particular content item (as indicated by block 32). The application server 10 receives a response to the request from the satellite content management server 30 (as indicated by block 34). The response may indicate either that no bandwidth is available, or a channel and a time slot identifying a satellite link for distributing the particular content item.

If a channel and a time slot are received, an act of sending information indicating the channel and time slot to the users that are to wirelessly receive the particular content item may be performed (as indicated by block 36). Based on the information, the users' devices (e.g. a satellite receiver) can tune to the channel at the particular time slot to receive the particular content item. At an appropriate time, the application server 10 transfers the particular content item to the satellite content management server 30 via a network 37 (as indicated by block 38). The satellite content management server 30, in turn, distributes the particular content item to the users over the channel and at the time slot (as indicated by block 40). The satellite content management server 30 uses a transmit dish 42 or an alternative transmit antenna to communicate the particular content item to a satellite 44 in an uplink signal. The satellite 44, in turn, broadcasts the particular content item in the form of a downlink signal receivable by a receiving dish 46 or an alternative receiving antenna for each of the users. As indicated by block 50, the application server 10 distributes the particular content item via the wireline network 12 to those devices not able to receive the particular content item via the satellite link. In one embodiment, the wireline network 12 comprises a DSL network so that the particular content item is received by a DSL modem 52.

If the response in block 34 indicates that sufficient bandwidth is unavailable, the application server 10 may either: (a) override the selection made in block 24 and select wireline links from which the users are to receive the particular content item, (b) delay distributing the particular content item until satellite bandwidth is available, (c) send a request to another satellite content management server, or (d) send a request to another type of wireless network (e.g. a non-satellite wireless network).

If wireline links are to be used to communicate the particular content item (e.g. as a result of a small number of requests or satellite bandwidth being unavailable), the application server 10 distributes the particular content item via the wireline network 12 to the users (as indicated by block 54). In one embodiment, the wireline network 12 comprises a DSL network so that the particular content item is received by the DSL modem 52.

At the customer premise, the particular content item is received by either the receiving dish 46 or the DSL modem 52. The receiving dish 46 may communicate the particular content item to a set top box 56. The set top box 56 outputs a display signal to a display device 60 such as a television or a monitor. The display device 60 can be used to display video and/or audio content items. The DSL modem 52 can communicate video and/or audio content items to the set top box 56 to enable display thereof by the display device 60. Computer software content items can be distributed from either the DSL modem 52 or the set top box 56 to a personal computer 62. In one embodiment, the personal computer 62 is directly connected to the set top box 56. The set top box 56 can act as a server in redistributing content items within the customer premise.

Various digital rights management acts may be performed to mitigate the potential for unauthorized individuals to access (e.g. to receive and/or use) the particular content item broadcast via satellite or another wireless network. An example is distributing licenses or otherwise authorizing specific devices to receive the particular content item. This act inhibits other devices (e.g. from non-requesting users) from storing the particular content item being transmitted via satellite. Another example is distributing licenses or otherwise authorizing specific devices to play back or use the particular content item. In this case, the content vendor may use the satellite feed to pre-publish the particular content item onto many or all devices, including those from non-requesting users. Licenses are issued or distributed after the particular content item is distributed, and when the particular content item is to be used or played back after proper transactions have be completed.

The application server 10 manages and coordinates license distribution between DSL-based distribution and satellite feed distribution. For example, the application server 10 may withhold pre-delivery of the license until contacted again by the end device for which the particular content item is to be used. Then, the device may be authenticated and issued a license to use the particular content item.

The acts described herein may be directed by computer software code embodied as computer-readable data on a computer-readable medium. Examples of the computer-readable medium include, but are not limited to, a magnetic storage medium such as a magnetic disk, an optical storage medium such as an optical disk, or an electronic storage medium such as an electronic memory. Preferably, the application server 10 includes a computer processor to perform the acts based on the computer software code.

It will be apparent to those skilled in the art that the disclosed subject matter may be modified in numerous ways and may assume many embodiments other than the forms specifically set out and described herein. For example, acts performed by the application server 10 may be performed by one or more other computing devices.

Accordingly, it is intended by the appended claims to cover all modifications which fall within the true spirit and scope of the present invention.

What is claimed is:

1. A method of distributing content comprising:
receiving at least one request for a particular content item;
based on the at least one request, determining a number of users who are to receive the particular content item and are capable of receiving the particular content item via a wireless link;
based on the number of users, selecting at least one of a wireline link and the wireless link from which the users are to receive the particular content item; and
distributing the particular content item to the users via the selected at least one link.

2. The method of claim 1 further comprising comparing the number of users to a preset threshold.

3. The method of claim 2 wherein said selecting comprises selecting the wireless link if the number of users is greater than the preset threshold.

4. The method of claim 2 wherein said selecting comprises selecting the wireline link if the number of users is less than the preset threshold.

5. The method of claim 1 wherein the wireless link comprises a satellite link.

6. The method of claim 5 further comprising:
requesting a satellite content management server to allocate bandwidth for distributing the particular content item;
receiving, from the satellite content management server, a channel and a time slot identifying the satellite link for distributing the particular content item; and
transferring the particular content item to the satellite content management server;
wherein said distributing comprises the satellite content management server distributing the particular content item to the users over the channel and the time slot.

7. The method of claim 6 further comprising:
sending information indicating the channel and the time slot to the users.

8. The method of claim 1 further comprising:
authorizing devices associated with the users to receive the particular content item.

9. The method of claim 8 wherein said authorizing comprises distributing licenses to enable the devices associated with the users to receive the particular content item.

10. The method of claim 1 further comprising:
authorizing devices associated with the users to play back the particular content item.

11. The method of claim 10 wherein said authorizing comprises distributing licenses to enable the devices associated with the users to play back the particular content item.

12. The method of claim 11 wherein at least one of the licenses is distributed after distributing the particular content item.

13. The method of claim 1 further comprising:
authorizing devices associated with the users to use the particular content item.

14. The method of claim 13 wherein said authorizing comprises distributing licenses to enable the devices associated with the users to use the particular content item.

15. The method of claim 14 wherein at least one of the licenses is distributed after distributing the particular content item.

16. The method of claim 1 wherein the wireless link comprises a wireless local area network link.

17. The method of claim 1 wherein the wireless link comprises an internet protocol over radio link.

18. The method of claim 1 wherein the wireline link comprises a digital subscriber line link.

19. The method of claim 1 wherein the particular content item comprises computer software.

20. The method of claim 1 wherein the particular content item comprises video content.

21. A system for distributing content, the system comprising:
an application server programmed to receive at least one request for a particular content item, to determine a number of users who are to receive the particular content item and are capable of receiving the particular content item via a wireless link, to select at least one of a wireline link and the wireless link from which the users are to receive the particular content item based on the number of users, and to communicate the particular content item to at least one of a satellite content management server and a landline network to distribute the particular content item to the users via the selected at least one link.

22. The system of claim 21 wherein the application server is to select by comparing the number of users to a preset threshold.

23. The system of claim 22 wherein the application server is to select the wireless link if the number of users is greater than the preset threshold.

24. The system of claim 22 wherein the application server is to select the wireline link if the number of users is less than the preset threshold.

25. The system of claim 21 wherein the application server is to:
request a satellite content management server to allocate bandwidth for distributing the particular content item; and
receive, from the satellite content management server, a channel and a time slot identifying the satellite link for distributing the particular content item.

26. The system of claim 25 wherein the satellite content management server is to distribute the particular content item to the users over the channel and the time slot.

27. The system of claim 25 wherein the application server is to send information indicating the channel and the time slot to the users.

28. The system of claim 21 wherein the application server is to authorize devices associated with the users to receive the particular content item.

29. The system of claim 28 wherein the application server authorizes the devices by distributing licenses to enable the devices associated with the users to receive the particular content item.

30. The system of claim 21 wherein the application server is to authorize devices associated with the users to play back the particular content item.

31. The system of claim 30 wherein the application server authorizes the devices by distributing licenses to enable the devices associated with the users to play back the particular content item.

32. The system of claim 31 wherein at least one of the licenses is distributed after distributing the particular content item.

33. The system of claim 21 wherein the application server is to authorize devices associated with the users to use the particular content item.

34. The system of claim 33 wherein the application server authorizes the devices by distributing licenses to enable the devices associated with the users to use the particular content item.

35. The system of claim 34 wherein at least one of the licenses is distributed after distributing the particular content item.

36. The system of claim 21 wherein the wireline link comprises a digital subscriber line link.

37. The system of claim 21 wherein the particular content item comprises computer software.

38. The system of claim 21 wherein the particular content item comprises video content.

39. A method comprising:
receiving at least one request for a particular content item;
based on the at least one request, determining a number of users who are to receive the particular content item and are capable of receiving the particular content item via a satellite link;
selecting at least one of a digital subscriber line (DSL) link and the satellite link from which the users are to receive the particular content item, wherein the satellite link is selected if the number of users is greater than a preset threshold, and wherein the DSL link is selected if the number of users is less than the preset threshold; and
when the satellite link is selected, requesting a satellite content management server to allocate bandwidth for distributing the particular content item, receiving, from the satellite content management server, a channel and a time slot identifying the satellite link for distributing the particular content item, and transferring the particular content item to the satellite content management server.
